(19) United States
(12) Patent Application Publication
(10) Pub. No.: US 2009/0064499 A1
(43) Pub. Date: Mar. 12, 2009

(54) METHOD AND BLANK FOR MANUFACTURING A COMPRESSOR BLOCK OF A SMALL-TYPE REFRIGERATION APPLIANCE, PARTICULARLY FOR A HERMETICALLY ENCLOSED REFRIGERANT COMPRESSOR ARRANGEMENT

(75) Inventors: Jesper Valbjoern, Kolding (DK); Kristoffer Riemann Hansen, Broager (DK); Anders Jakob Madsen, Nordborg (DK)

Correspondence Address: MCCORMICK, PAULDING & HUBER LLP, CITY PLACE II, 185 ASYLUM STREET, HARTFORD, CT, 06103, US

(73) Assignee: Danfoss Compressors GmbH, Flensburg (DE)

(21) Appl. No.: 12/186,595

(22) Filed: Aug. 6, 2008

(30) Foreign Application Priority Data
Aug. 16, 2007 (DE) 10 2007 038 444.2

(51) Int. Cl. B23P 15/00

(52) U.S. Cl. 29/888.02; 428/542.8

(57) ABSTRACT

The invention concerns a method and a blank (30) for manufacturing a compressor block of a small-type refrigeration appliance, particularly for a hermetically enclosed refrigerant compressor arrangement, the blank comprising a handling section (34) and at least two working areas (43, 46). The blank (30) is clamped in a working arrangement at a handling section (34), the blank being worked during maintenance of the clamping. It is endeavoured to reduce the dimensions of a compressor block, though maintaining the opportunity of performing several working steps during one clamping process. For this purpose, it is provided that the handling section (34) is removed after the working.

### CROSS REFERENCE TO RELATED APPLICATION

Applicant hereby claims foreign priority benefits under U.S.C. § 119 from German Patent Application No. 10 2007 038 444.2 filed on Aug. 16, 2007, the contents of which are incorporated by reference herein.

### FIELD OF THE INVENTION

The invention concerns a method for manufacturing a compressor block of a small-type refrigeration appliance, particularly for a hermetically enclosed refrigerant compressor arrangement, in which a blank is used, the blank being clamped in a working arrangement at a handling section, the blank being worked at least two different working areas during maintenance of the clamping.

Further, the invention concerns a blank for manufacturing a compressor block of a small-type refrigeration appliance, particularly for a hermetically enclosed refrigerant compressor arrangement, with a handling section and at least two working areas.

### BACKGROUND OF THE INVENTION

In the following, the invention will be described on the basis of a compressor block for a small-type refrigeration appliance, as used in domestic appliances, for example refrigerators or freezers, or in mobile refrigeration systems, for example in cars. A typical compressor for such applications is shown in DE 26 17 370 A1.

Such a compressor only supplies a limited amount of refrigeration, for example in the area of 100 W at an evaporation temperature of −5° C. and a condensation temperature of +55° C. Due to the refrigeration supply, it only requires relatively small dimensions. Usually, the compressor block serves the purpose of adopting one single cylinder, housing a crankshaft and connecting to the stator of an electrical drive motor. The cylinder has to be manufactured with a relatively high accuracy, so that large inner leakages will not eventually appear during operation. Also the bearing of the crankshaft, which usually comprises at least one radial bearing and an axial bearing, must be manufactured with a certain accuracy. Further, the cylinder and the bearing of the crankshaft must be aligned relatively accurately to each other to prevent an edging of the piston reciprocating in the cylinder. For cost reasons, it is therefore endeavoured to work all required working areas in one working arrangement, for which only one clamping process of the blank is required. Preferably, all working steps are then made during this clamping process. In spite of the clamping, all required working tools must have sufficient access and free space to carry through the working. In consideration of this requirement, the compressor block needs a certain size, so that during working it can on the one hand be fixed or clamped with the required security and reliability; on the other hand provide the working tools with the required access to the blank.

### SUMMARY OF THE INVENTION

The invention is based on the task of reducing the dimensions of the compressor block, though maintaining the opportunity of making several working steps during one clamping process.

With a method as mentioned in the introduction, this task is solved in that the handling section is removed after the working.

Thus, it is ensured that during working the compressor block can be clamped and that several working steps can be performed during one clamping process. For example, in one position the cylinder can be bored and refinished, whereas in a second position a bore for the bearing section of the crankshaft can be made. In a third step, the front face of the cylinder can then be machine-flushed to permit the positioning of a cylinder head. At a fourth position, a further face around the bearing bore can be machine-flushed to form an axial bearing. During all these working processes, the blank or the compressor block to be manufactured is clamped at the handling section, so that changes of the clamping are not required. Sufficient free space is available for the working tools. When the compressor block is then almost finished, meaning that it no longer needs to be clamped, to enable further working steps, the handling section can be removed. This reduces the dimensions of the compressor block, even though the advantages of the same clamping could be used during the working steps.

Preferably, the handling section is formed during manufacturing of the blank. For example, the blank can be moulded. The handling section is formed during the moulding, so that after finishing the moulding process it is available for clamping the blank.

Preferably, a predetermined breaking point is provided at the handling section. The predetermined breaking point is preferably located, where the handling section is to be separated from the otherwise completely worked compressor block, that is, between the handling section and the compressor block. The predetermined breaking point makes it easier to separate the handling section from the compressor block.

It is preferred that the handling section is knocked or broken off. If a predetermined breaking point is available, a simple knocking or pressing action will ensure that the handling section is broken off from the compressor block. No further tools, such as a cutter or a saw, will be required for breaking off the handling section.

Preferably, the predetermined breaking point is made as a notch. A notch will concentrate the tensions provoked by a knocking or a pressing action, so that eventually the handling section can be broken off.

Preferably, the predetermined breaking point is made when manufacturing the blank. If the blank is made as a moulded component, a corresponding projection can be made already in the mould, which will finally form the notch.

Preferably, the handling section is made at an edge area of the compressor block. This may require somewhat longer lever arms, which will have to be considered with regard to the force distribution during the working. As, however, the removable handling section ensures that the compressor block can be made with somewhat smaller dimensions, this disadvantage is acceptable. If the handling section is made at an edge area of the compressor block, the remaining areas are available for the access of working tools.

It is preferred that the edge area has a maximum distance from areas of the compressor block, which are critical with regard to manufacturing tolerances. Thus, deformations of these areas, which could lead to leakages in the cylinder gap or wear of the bearings, when separating the handling section, can be prevented.

Preferably, the handling area is permitted to project radially in relation to a bearing bore for a crankshaft. Thus, the handling area can also be used for the simple positioning of the blank in machine tools. Then, the handling area extends along a main axis of a coordinate system, whereas the drill for making the bearing bore can be located in a different main axis.

It is also advantageous, if the handling section is located in parallel to an axis of a cylinder. Thus, the handling section of the blank can be supported with sufficient stability against the forces, which appear during manufacturing of the cylinder bore. Also the face grinding of the front face of the cylinder can easily be managed in this manner. A major advantage also exists in that in a manner of speaking the handling section has the largest distance from the cylinder, so that a deformation of the cylinder during the removal of the handling section will not occur.

With a blank as mentioned in the introduction, the task is also solved in that the handling section can be separated from the compressor block.

As explained above in connection with the method, this is a way to achieve that, during several working steps or even throughout the whole working, the blank can be held in one clamping position. Nevertheless, dimensions, which are only caused by the clamping, are not required, as the handling section can be removed after the working.

Preferably, a predetermined breaking point is located between the compressor block and the handling section. Then, the handling section can be knocked or broken off, so that no further cutting tools are required to remove the handling section.

Preferably, the handling section has a maximum distance from an area of the compressor block, which is critical with regard to manufacturing tolerances. Then, the removal of the handling section will have no damaging effect on the critical area, for example the cylinder.

Preferably, the handling section is directed radially in relation to a bearing bore for a crankshaft. A bearing bore has not yet been made in the blank. However, it is known, where this bearing bore is to be located. Thus, the statement refers to the finished bearing bore. As explained above in connection with the method, the handling section can then be aligned in parallel to a main axis of the coordinate system and the drill for making the bearing bore can then be aligned to another main axis. This makes it easier to adjust the machine tools.

It is also advantageous, if the handling section is aligned in parallel to an axis of a cylinder. Thus, on the one hand, the handling section is as far as possible away from the cylinder, so that the cylinder is not negatively influenced during separation of the handling section. On the other hand, the handling section and the drill for making the cylinder bore can be aligned in the same direction, which also simplifies the working.

### BRIEF DESCRIPTION OF THE DRAWINGS

In the following, the invention is described on the basis of a preferred embodiment in connection with the drawings, showing:

FIG. 1 is a longitudinal section through a refrigerant compressor arrangement,

FIG. 2 is a side view of a compressor block blank,

FIG. 3 is a top view of the compressor block blank,

FIG. 4 is a side view of a worked compressor block, and

FIG. 5 is a top view of a finished compressor block after separating the handling section.

### DETAILED DESCRIPTION

A refrigerant compressor arrangement 1 has an enclosure 2 with an upper part 3 and a lower part 4. The upper part 3 has a flange 5 and the lower part 4 has a flange 6. The upper part 3 and the lower part 4 are welded together or otherwise tightly connected to each other along the flanges.

In the enclosure is located a unit 7, which comprises an electric motor 8 and a compressor section 9. Via several springs 10, 11, of which two can be seen; the unit 7 is supported in the lower part 4.

The motor 8 comprises a stator 12 and a rotor 13. The rotor 13 is unrotatably connected to a crankshaft 14. The crankshaft 14 is rotatably supported in a compressor block 15. For this purpose, the compressor block 15 comprises a radial bearing 16 and an axial bearing 17. The radial bearing 16 is located in a bearing section 18 of the compressor block 15.

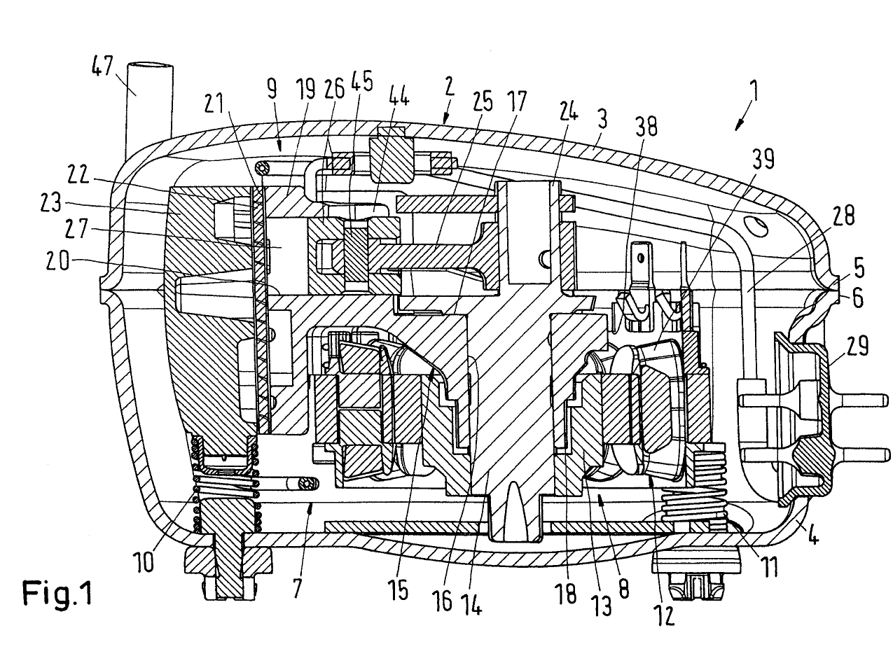

The stator 12 of the motor 8 is fixed on the compressor block 15. Here, the fixing is located outside the drawing plane and can therefore not be seen in FIG. 1.

Further, the compressor block 15 comprises a cylinder section 19, in which a cylinder 20 is formed. The front face of the cylinder section 19 has a bearing surface 21, a valve plate 22 being adjacent to the bearing surface 21. On the side of the valve plate 22 facing away from the compressor block a cylinder head cover 23 is located.

The crankshaft 14 has a crank pin 24, on which a connecting rod 25 is rotatably supported. The connecting rod 25 is connected to a piston 26, which can reciprocate in the cylinder 20. By means of the crank pin 24 the connecting rod 25 ensures that the rotating movement of the crankshaft 14, which is caused by the electric motor 8, is converted to a reciprocating movement of the piston 26. This causes a periodical reduction and increase of a pressure chamber 27 formed in the cylinder 20, meaning that refrigerant gas, which is sucked into the enclosure 2 through a suction connection 47, is compressed and passed on to a connected refrigeration system through a supply pipe 28. An electric connection arrangement 29 is provided for the electrical supply of the motor 8.

The dimensions of the refrigerant compressor arrangement 1 should be kept as small as possible. In the most cases, the size of domestic refrigeration appliances is limited by other outer dimensions, for example the depth and the height of kitchen furniture. If it is desired to increase the space available for the refrigeration, it will be favourable to keep the refrigerant compressor arrangement as small as possible.

Refrigerant compressor arrangements for domestic refrigeration appliances and similar applications can only supply a limited amount of refrigeration. Accordingly, a relatively small electric motor 8 and also a relatively small cylinder section 19 can be used. However, until now the dimensions of the compressor block 15 had a lower limit, as the compressor block had to be worked. For cost reasons it has been endeavoured to perform a working of all required surfaces, working sections and the like in one single working machine or working arrangement, which would require only one clamping process of the blank. All working steps should be performed during this clamping. A renewed clamping of the blank between individual working steps would have two disadvantages. Firstly, each renewed clamping generates costs. Secondly, it is relatively difficult to maintain the highest level of accuracy during a renewed clamping. For example, the bores for the crankshaft 14 and the cylinder 20 must have a relatively accurate alignment in order to prevent wear during later operation.

A clamping tool requires a certain space around the blank to be worked. Working tools cannot be used in the area, in which the clamping tool is located. Accordingly, it is difficult, when the dimensions of the compressor block are small, to perform the desired working processes during one clamping process.

In the following, a solution to this problem will be described.

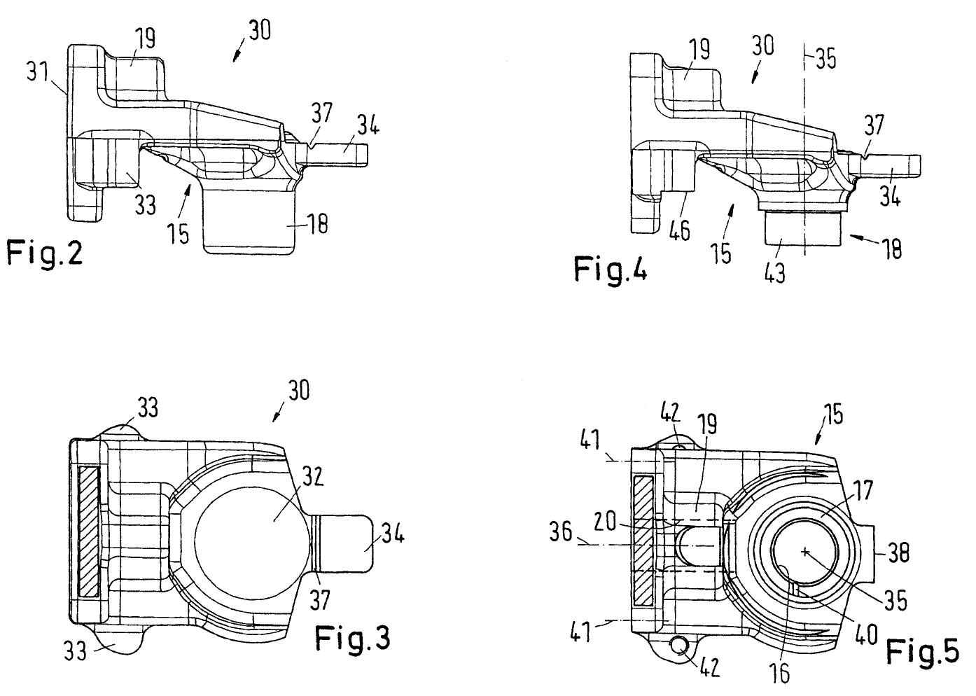

FIG. 2 shows a blank 30 of the compressor block 15 in the unworked state. However, the bearing section 18 and the cylinder section 19 can be seen. Also a front face 31 can be seen, which has to be worked to form the bearing surface 21. The top-view in FIG. 3 also shows a surface 32, in which the axial bearing 18 will be formed. The FIGS. 2 and 3 also show lateral projections 33, on which the stator 12 of the motor 8 can be fixed.

To enable the clamping of the blank 30, the blank 30 has a handling section 34, which projects from the blank 30. The handling section 34 extends (in relation to the subsequently finished bores) radially to an axis 35 of the radial bearing 16. Further, the handling section 34 extends in parallel to an axis 36 of the cylinder 20. In this connection, the handling section 34 is located on the side of bearing section 18 opposite to the cylinder 20. Thus, changes in the shape of the cylinder during the separation of the handling section 34 from the finished blank 30 are not to be feared.

For reasons of clarity, a part of the blank 30 is also called the compressor block 15. A notch 37 is formed between the compressor block 15 and the handling section 34. This notch 37 can already be made, when the blank 30 is manufactured, for example by moulding. However, the notch 37 can also be made during the working.

When the compressor block 15 has been finished, the handling section 34 can be broken off from the compressor block 15 simply by means of a knocking or a pressing action. An additional working is not required. A breaking edge 38 thus appears, which has, as shown in FIG. 1, a relatively small distance from the crankshaft 14, so that the compressor block 15 can be inserted relatively far into the stator 12 of the motor 8. In the radial direction, the breaking edge is at least substantially inside the winding 39 of the stator 12 of the motor 8.

The blank 30 reaches the working arrangement, for example a robot with several tools and automatic tool change, as a casting. The working arrangement can grasp and clamp the blank 30 at the handling arrangement 34. Then, the cylinder 20 is bored in the cylinder section 19, and the front face 31 is worked to make the bearing surface 21. A hole is bored through bearing section 18 to form the radial bearing 16. The surface 32 is worked to make the axial bearing 17. Further, an oil groove 40 can be made. Additionally, openings for clamp bolts can be bored in the front face 31, by means of which the valve plate 22 and the cylinder head cover 23 can be connected to the compressor block 15. Here, they are indicated by axes 41. In the projections 33 bores 42 are provided, through which screw bolts can be guided to connect the compressor block 15 to the stator 12 of the motor 8. The bearing section 18 is worked to provide a diameter reduction 43, so that, as can be seen in FIG. 1, the bearing section 18 can be inserted relatively deeply into the rotor 13.

At the upper side of the compressor block 15, in the cylinder section 19, a recess 44 is made, which is used for mounting a piston pin 45 that connects the piston 26 to the connecting rod 25.

At the bottom side of the projections 33 bearing surfaces are worked, at which the stator 12 of the motor 8 bears.

As soon as the working of the compressor block 15 is finished, the handling section 34 is removed by means of simple knocking or pressing action along the notch 37, which forms a predetermined breaking point. This means that the handling section 34 is broken off. However, it can also be removed from the compressor block by means of milling or grinding.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A method for manufacturing a compressor block of a small-type refrigeration appliance, particularly for a hermetically enclosed refrigerant compressor arrangement, in which a blank is used, the blank being clamped in a working arrangement at a handling section, the blank being worked at least two different working areas during maintenance of the clamping, wherein the handling section is removed after the working.

2. The method according to claim 1, wherein the handling section is formed during manufacturing of the blank.

3. The method according to claim 2, wherein a predetermined breaking point is provided at the handling section.

4. The method according to claim 3, wherein the handling section is knocked or broken off.

5. The method according to claim 3, wherein the predetermined breaking point is made as a notch.

6. The method according to claim 3, wherein the predetermined breaking point is made when manufacturing the blank.

7. The method according claim 1, wherein the handling section is made at an edge area of the compressor block.

8. The method according to claim 7, wherein the edge area has a maximum distance from areas of the compressor block, which are critical with regard to manufacturing tolerances.

9. The method according to claim 1, wherein the handling area is permitted to project radially in relation to a bearing bore for a crankshaft.

10. The method according to claim 1, wherein the handling section is located in parallel to an axis of a cylinder.

11. A blank for manufacturing a compressor block of a small-type refrigeration appliance, particularly for a hermetically enclosed refrigerant compressor arrangement, with a handling section and at least two working areas, wherein the handling section can be separated from the compressor block.

12. The blank according to claim 11, wherein a predetermined breaking point is located between the compressor block and the handling section.

13. The blank according to claim 11, wherein the handling section has a maximum distance from an area of the compressor block, which is critical with regard to manufacturing tolerances.

14. The blank according to claim 11, wherein the handling section extends radially in relation to a bearing bore for a crankshaft.

15. The blank according to claim 11, wherein the handling section is aligned in parallel to an axis of a cylinder.
